(19) United States
(12) Patent Application Publication
(10) Pub. No.: US 2013/0048400 A1
(43) Pub. Date: Feb. 28, 2013

(54) MACHINE ACCESS DEVICE

(71) Applicants: William Holdener, Peoria, IL (US); Eswara P. Dontamsetti, Hyderabad (IN)

(72) Inventors: William Holdener, Peoria, IL (US); Eswara P. Dontamsetti, Hyderabad (IN)

(73) Assignee: Caterpillar Inc., Peoria, IL (US)

(21) Appl. No.: 13/222,331

(22) Filed: Aug. 31, 2011

(51) Int. Cl. B62D 25/22; B60R 3/02; E06C 5/02

(52) U.S. Cl. 180/89.1; 182/115

(57) ABSTRACT

An access device for a mobile machine that includes a platform, an upper, fixed position ladder extending downward from the platform, and a lower ladder pivotally connected to a lower end of the upper ladder, the lower ladder having a rail arm that extends from a rear face of the lower ladder that is connected to a push arm that extends above the platform, wherein a downward force on the push arm pivots the lower ladder from a lowered to a raised position. A latch mechanism may be provided on the push arm, the push arm connected to a pivoting striker arm such that downward movement of the push arm causes the striker arm to pivot upward to engage the latch.

### TECHNICAL FIELD

This disclosure relates generally to access devices for mobile machinery, and, more particularly, to devices having a ladder assembly moveable between a lowered and stowed position that allows access to the platforms or the operator station of such machinery. More particularly, the present disclosure relates to an access device that has an upper, stationary ladder and a lower, pivotal ladder, together with an improved operating mechanism having a push arm and latch assembly.

### BACKGROUND

A number of devices, including steps, ramps, ladders, elevators, e.g., are currently employed to provide personnel with access to elevated positions, such as platforms and the operator station, on large mobile machinery. Such machines are used in various industries, such as mining, construction, forestry and waste management, and include, for example, loaders, excavators, motor graders, material handlers, compactors, trucks, dozers, cranes, and a wide range of other specialized machines. In many cases, the access device may, in whole or in part, be movable to a stowed position during ordinary operations to provide greater ground clearance and to avoid damage to the machine or objects in the operating environment. Typically, this includes ladders wherein a portion of the ladder is extendable or wherein a ladder is pivoted about one end thereof.

For example, U.S. Pat. No. 6,068,277 to Magnussen discloses an access system for an earth-moving machine, such as a motor grader, that includes rear stairs that provide access from ground level to a rear fixed deck structure. The stairs include a pivot such that a lower stair portion of the stairs is collapsible or foldable. A hydraulic cylinder is connected on an outer surface between the upper and lower rails to move the stairs between the raised and lowered positions.

### SUMMARY OF THE INVENTION

In one aspect, the present disclosure describes an access device for a mobile machine, such as a motor grader, that includes an upper platform and an upper, fixed position ladder connected at an upper end to the platform. A lower ladder is pivotally connected to the upper ladder, and includes opposing rails, at least one of the rails having a rail arm that extends from a rear face of the lower ladder. A push arm is provided with a first end extending above an upper surface of the platform and including a push handle. A second end of the push arm is pivotally connected to the rail arm such that a downward force of the push arm pivots the lower ladder from a lowered position to a raised position.

In another aspect, described is a mobile machine that includes a machine frame, a plurality of traction devices supporting the machine frame, and a power source drivingly connected to at least one of the fraction devices for propulsion of the machine. A work implement may be operatively connected to the machine frame. The mobile machine includes an access device for a mobile machine, such as a motor grader, that includes an upper platform and an upper, fixed position ladder connected at an upper end to the platform. A lower ladder is pivotally connected to the upper ladder, and includes opposing rails, at least one of the rails having a rail arm that extends from a rear face of the lower ladder. A push arm is provided with a first end extending above an upper surface of the platform and including a push handle. A second end of the push arm is pivotally connected to the rail arm such that a downward force of the push arm pivots the lower ladder from a lowered position to a raised position.

In yet another aspect, the present disclosure describes an access device for a mobile machine, such as a motor grader, that includes an upper platform and an upper, fixed position ladder connected at an upper end to the platform. A lower ladder is pivotally connected to the upper ladder, and includes opposing rails, at least one of the rails having a rail arm that extends from a rear face of the lower ladder. A push arm is provided with a first end extending above an upper surface of the platform and including a push handle. A second end of the push arm is pivotally connected to the rail arm such that a downward force of the push arm pivots the lower ladder from a lowered position to a raised position. The upper ladder and lower ladder are aligned along a ladder axis when in the lowered position, the rail arm including a first section that extends from a rear face of the lower ladder at an angle relative to the axis, and a second section that extends upward from an end of the first section, the push arm being pivotally connected to the second section. A latch assembly is also provided that is connected to the push arm, a striker arm being pivotally connected to a striker bracket connected to the platform, the striker arm pivotally connected at a first end of the push arm such that as the push arm moves from an upper push arm position to a lower push arm position, the striker arm pivots about the striker bracket to engage the latch assembly.

These and other aspects and advantages of the present disclosure will become apparent to those skilled in the art upon reading the following detailed description in connection with the drawings and appended claims.

### BRIEF DESCRIPTION OF THE DRAWINGS

FIG. 1 is a rear perspective view of a mobile machine having an access device in accordance with one embodiment of the present disclosure;

FIG. 2 is an enlarged perspective view of a portion of the mobile machine and access device shown in FIG. 1;

FIG. 3 is a right side perspective view of an access device in accordance with an embodiment of the present disclosure, shown in a lowered position;

FIG. 4 is a right perspective view of the access device of FIG. 3, shown in a raised position;

FIG. 5 is a top left perspective view of the access device of FIG. 3, shown in a lowered position;

FIG. 6 is a top left perspective view of the access device of FIG. 3, shown in a raised position;

FIG. 7 is a perspective view of a latch mechanism in accordance with one embodiment of the present disclosure;

FIG. 8 is a perspective view of an upper portion of a push arm and latch release handle in accordance with one embodiment of the present disclosure;

FIG. 9 is a cross-section of a push arm and latch release handle as shown in FIG. 8;

FIG. 10 is a cross-section of a latch mechanism as shown in FIG. 7;

FIG. 11 is a bottom perspective view of a portion of the access device of FIGS. 3-6;

FIG. 12 is a bottom perspective view of a portion of the access device of FIGS. 3-6.

### DETAILED DESCRIPTION

Throughout the drawings, like numerals will be used to identify similar features, except where expressly otherwise indicated.

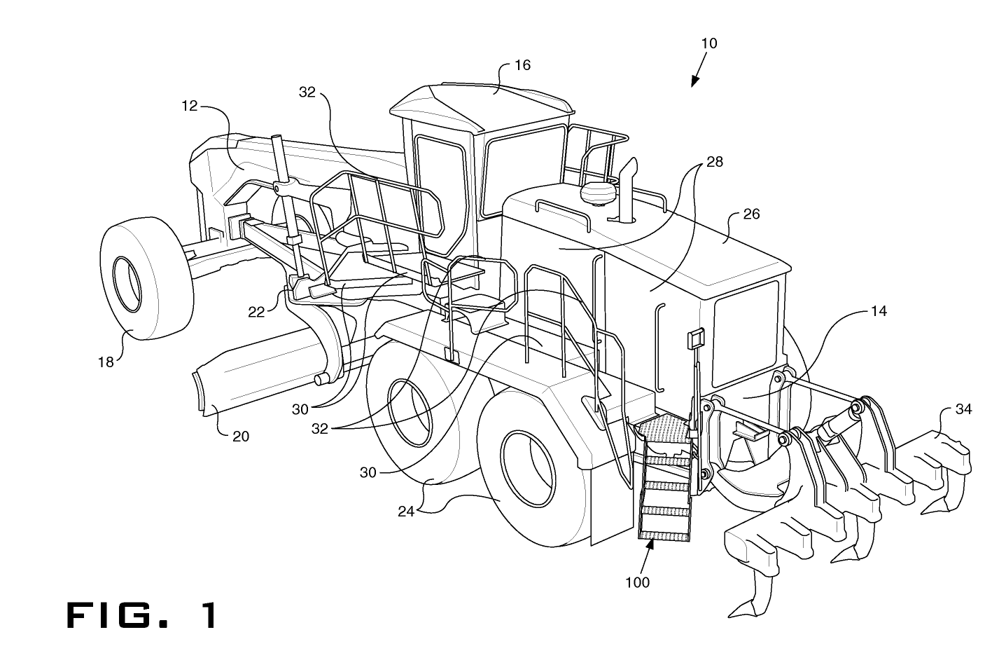

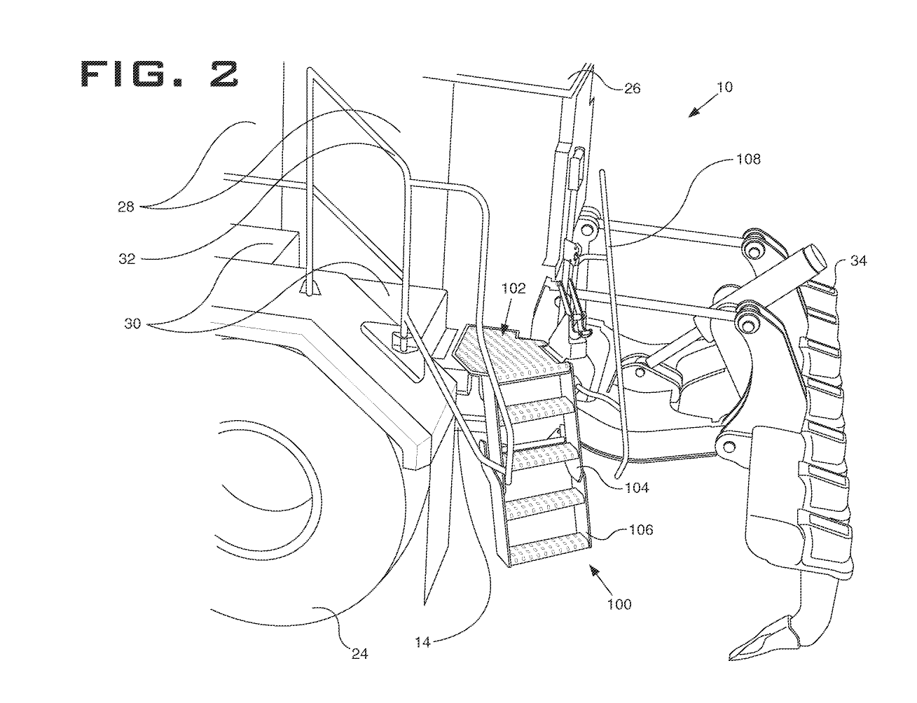

An exemplary embodiment of a mobile machine 10 is shown generally in FIGS. 1-2. The machine may be a motor grader, as shown, or any other on or off-highway machine. In particular, this may include machines used in various industries, such as mining, construction, agriculture, forestry and waste management. Other exemplary machines 10 may include, for example, wheeled or tracked loaders, dump trucks, wheeled or tracked dozers, wheeled or tracked excavators, water trucks, articulated trucks, material handlers, pipelayers, compactors, cranes, shovels and similar heavy mobile equipment.

The motor grader 10 of FIGS. 1-2 generally includes a front frame structure 12 and a rear frame structure 14 that are pivotally connected at an articulation joint (not shown) positioned to the rear of the operator station 16. The front frame structure 12 is supported at one end by steerable front traction devices, front tires 18. Mounted to the front frame structure 12 is the operator station 16 and the main implement 20, which in this case is a positionable blade connected to the front frame structure 12 by a drawbar-circle-moldboard (DCM) 22. The rear frame structure 14 is supported by the rear tandem which allows pivoting of the driven rear traction devices 24. Connected above the rear frame structure 14 is the engine and cooling system enclosure 26 which has one or more access panels 28 for servicing the components therein. Also connected to the rear frame structure 14 is a secondary implement, ripper 34.

As shown, the machine 10 includes a number of elevated platforms 30 that serve to access various service points and the operator station 16, which contains the primary controls of the motor grader for ordinary operation. Surrounding the platforms 30 are a plurality of guardrails 32 that may be employed for support and safety of operators and other personnel. At the rear of the machine 10, also connected to the rear frame structure 14, is an access device 100, shown in greater detail in FIGS. 2-6. The access device 100 generally includes an access platform 102, stationary upper ladder 104, lower ladder 106, access handrail 108, and operating mechanism 110. The access device 100 provides for convenient access to the machine platforms 30 and the operator station 16.

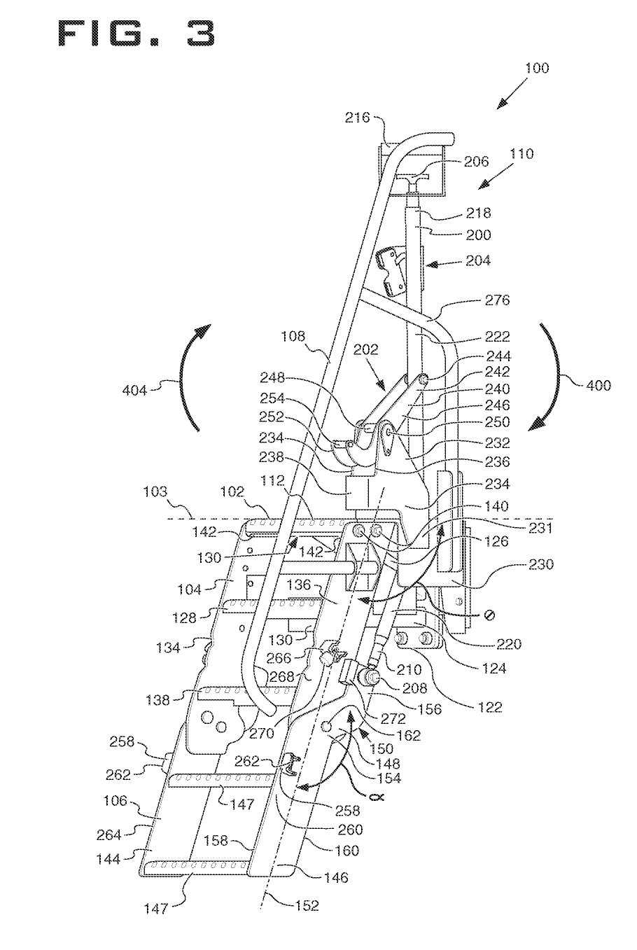

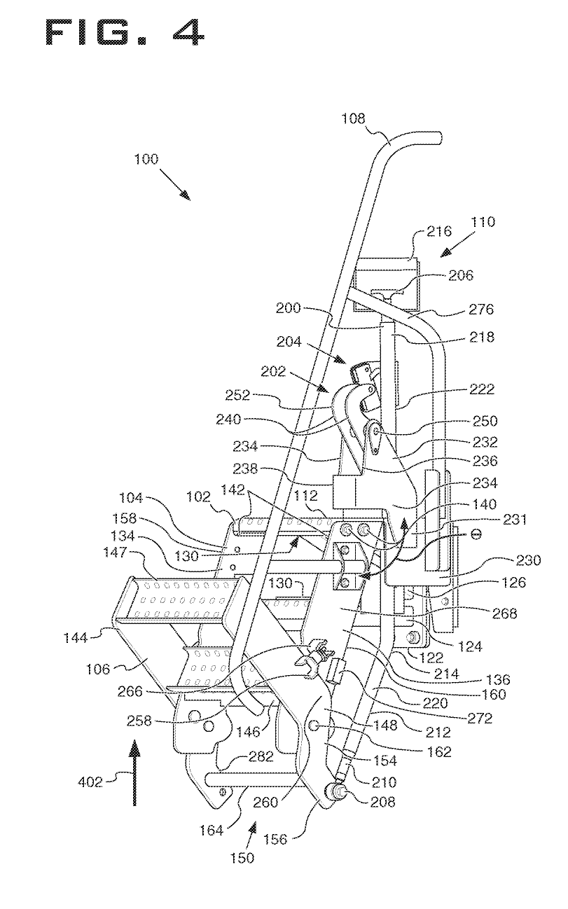

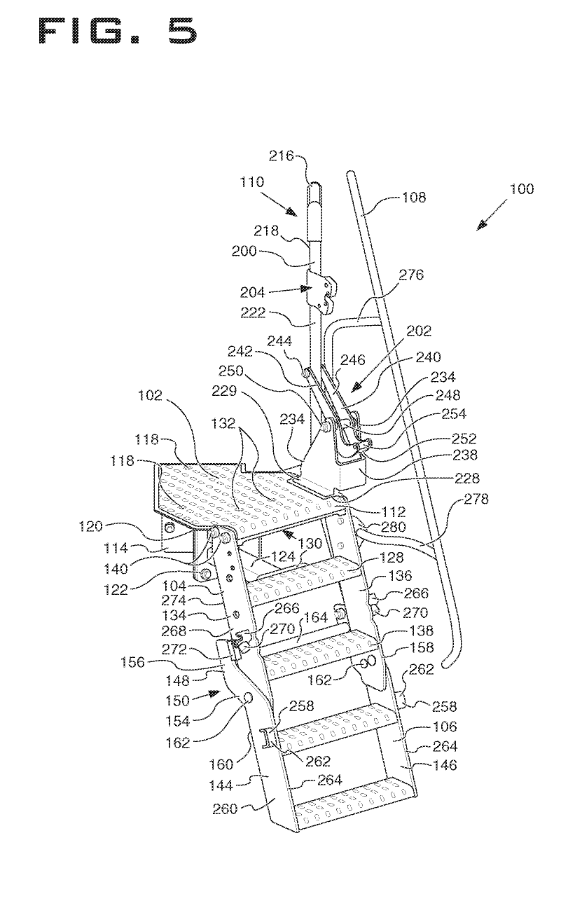

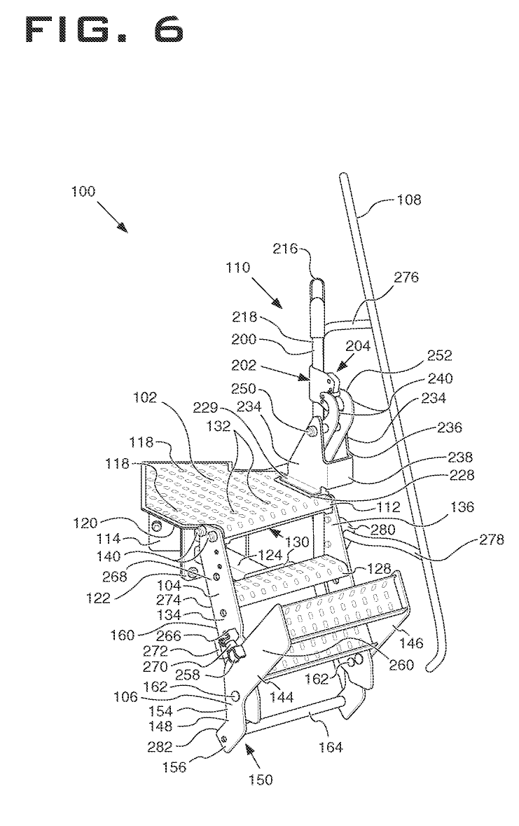

FIGS. 3-4 and 5-6 illustrate the access device 100 from the right and left sides, respectively, while FIGS. 3 and 5 correspond to what may be referred to herein as the “lowered”, “operating” or “first” position; and FIGS. 4 and 6 demonstrate what may be referred to as the “raised”, “stowed” or “second” position.

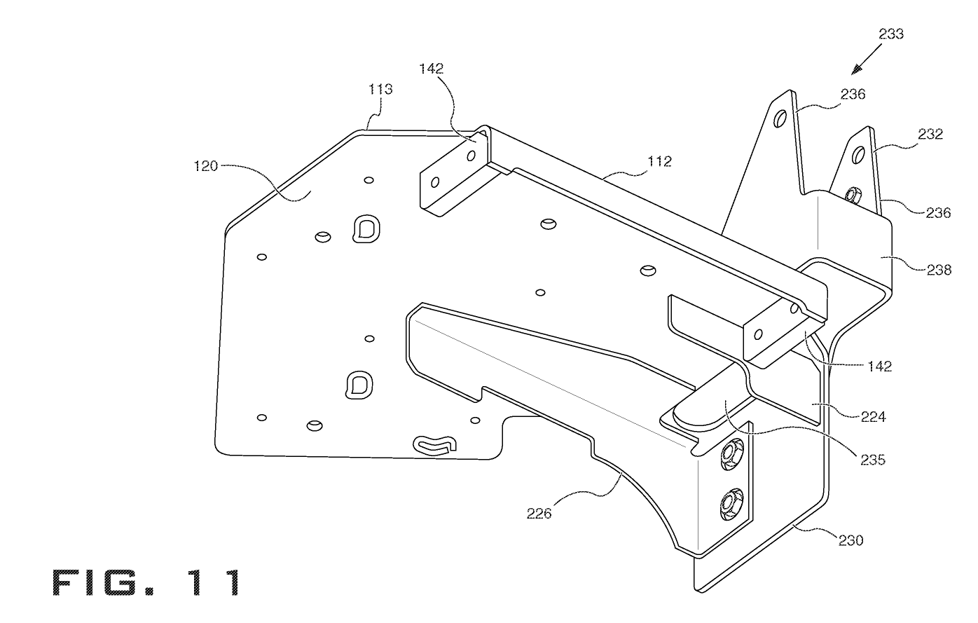

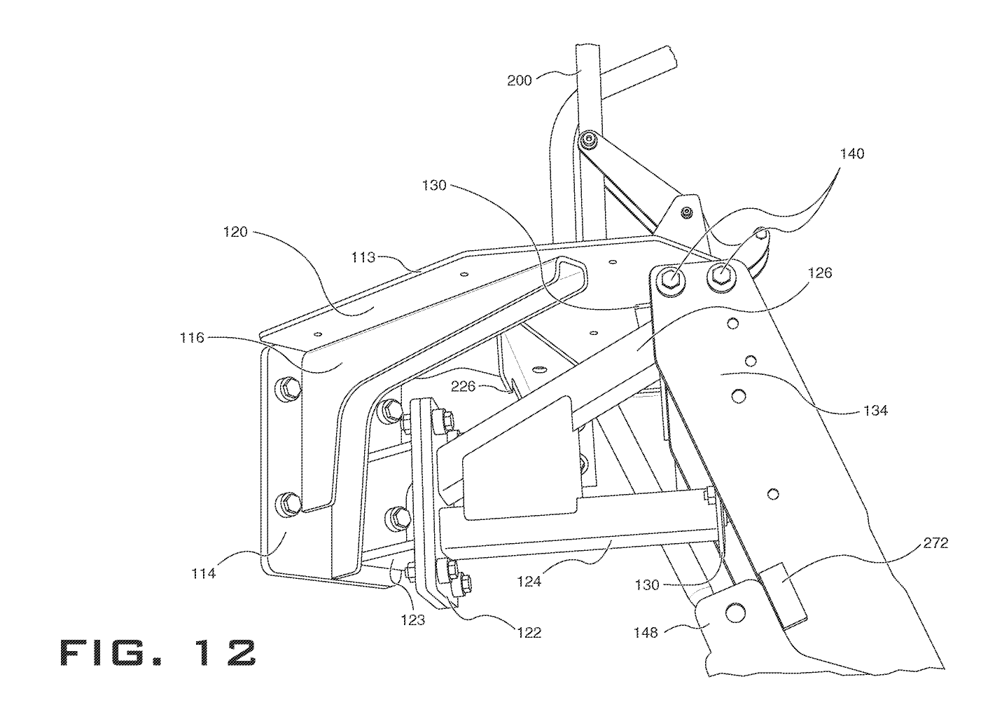

The access platform 102 defines a first planar surface 103, and has a platform edge 112 which may be rounded, as shown. The access platform 102 may be constructed, for example, of perforated steel treadplate that provides increased traction and allows fluids and debris to escape, the treadplate overlaying and riveted or otherwise affixed to a platform base plate 113, as best shown in FIGS. 11-12.

The access platform 102 may be attached to the rear frame structure 14 by a first mounting plate 114 and cantilevered U-shaped beam 116 that extends perpendicular to the first mounting plate 114 along a bottom surface 120 of the platform base plate 113, secured thereto by fasteners or bolts 118 (FIGS. 5-6). A second mounting plate 122 is secured to the first mounting plate 114 by an intermediate mount structure (123), the second mounting plate 122 providing attachment for an angled rectangular tube support (angled support member) 126 that extends between the second mounting plate 122 and the bottom surface 120 of platform base plate 113 via fasteners 132; and, for a similar ladder tube support (ladder support member) 124 that extends from the second mounting plate 122 to the uppermost, top step 128. The ends of the support members 124,126 are welded to an end plate 130, the end plate 130 of the angled support member 126 being connected to the access platform 102 by fasteners or bolts 132. The ladder support member 124 extends substantially parallel to the access platform 102 and rigidly connects via the respective end plate 130 to a rear portion of step 128.

The first, upper ladder 104 includes opposed elongated plates or rails (first and second rail) 134,136, and a plurality of steps, in this instance an upper and lower step 128, 138, that extend between the rails 134,136. Additional steps may be provided at regular intervals with a longer upper ladder 104. The steps of both the upper and lower ladder 104,106 may be constructed of the same perforated steel as the access platform 102. Other suitable materials are well known in the art.

The upper ladder 104 is stationary, being fixed in position by bolted connections 140 and the ladder support member 124. The bolted connections 140 are between an upper end of the rails 134,136 and a pair of blocks 142 underlying and connected (welded) to the bottom surface 120 of the platform base plate 113 adjacent the platform edge 112. Thus, the upper ladder 104 extends downward at an angle θ (FIG. 3) of approximately 110° relative to the access platform 102. This provides a comfortable and safe climbing angle for operators and other personnel, the upper surface of the steps 128,138 being substantially parallel to the access platform 102 and planar surface 103. Of course, other angles of inclination may be employed dependant upon the application and type of steps or rungs to be employed.

Lower ladder 106 also includes opposed elongated plates, a first rail 144 and second rail 146, and a plurality of spaced steps 147 extending between the rails 144,146. The top portion 150 of the rails 144,146 includes a rail arm 148 that includes a first section 154 that extends at an angle α from a common axis 152 of the upper and lower ladders 104,106, and from a front face 158 towards a rear face 160 of the ladders 104,106 when in the lowered position shown in FIGS. 3 and 5. A second section 156 of the rail arm 148 extends upward from an end of the first section 154, and may be parallel to axis 152, as shown. The rails 144,146 of the lower ladder 106 are pivotally connected via pins 162 to the rails 134,136 of the upper ladder 104. In one embodiment, as shown, the pivotal connection is within the rail arm 148, and more particularly, within the first section 154 of the rail arm 148 of the lower rails 144,146. An elongated cross support 164 extends between the second sections 156 of the first and second lower rails 144,146 behind the rear face 160, while the second section 156 of the second rail 146 also provides a connection point for operating mechanism 110.

The operating mechanism 110 generally includes a push arm 200, striker arm assembly 202, latch assembly 204, and latch release 206. The push arm 200 consists of an elongated rigid component that is pivotally connected at a first, ladder end 210 via arm pin 208 to the top portion 150 of lower rail 146, and extends from that connection to a point above the access platform 102 and a second end 218 that includes a handle 216. The handle 216 is thus positioned to be acted upon by personnel desiring to raise or lower the lower ladder 106 from the access platform 102. The push arm 200 may include a bend 214 (FIG. 4) that creates a first segment 220 that is axially aligned with the second section 156 of the rail arm 148 when the lower ladder 106 is in the lowered position (FIGS. 3 and 5), and a second, substantially vertical segment 222 that terminates at second end 218.

Referring to FIG. 11, extending downward from the platform base plate 113 is a side plate 230 that is reinforced by front and rear brackets 224,226. A striker bracket 232 is welded to an upper surface 228 of the platform base plate 113 via flange 229 (FIGS. 5,6) and via extension 231 (FIGS. 3,4), and includes a pair of vertically aligned, parallel striker bracket plates 234 that are connected along a bottom portion of a front edge 236 by a rectangular front plate 238. The bracket plates 234 are spaced to provide a channel and guide for striker arm 202 and push arm 200, the channel 233 (FIG. 11) further defined by an opening in 235 in the platform base plate 113.

The striker arm assembly 202 consists of a pair of identical, parallel, spaced striker arms 240. The push arm 200 is disposed between a first end 242 of the striker arms 240 and connected by a horizontally aligned pivot pin 244. A first, strait section 246 of the striker arms 240 connects the push arm 200 to the striker bracket plates 234, the striker arms 240 being disposed against an internal wall of the spaced striker bracket plates 234. A cylindrical boss 248 forms a rigid connection between the two striker arms 240, a flag pin 250 disposed within the boss 248 and extending through the striker arms 240 and striker bracket plates 234 to form another pivotal connection. A second portion 252 of the striker arms extends from the pivotal connection 250 to the striker 254, which may be a cylindrical rod extending between the striker arms 240 adjacent a second end 256 thereof. In one embodiment (as shown), the second portion 252 may include a hook or curve.

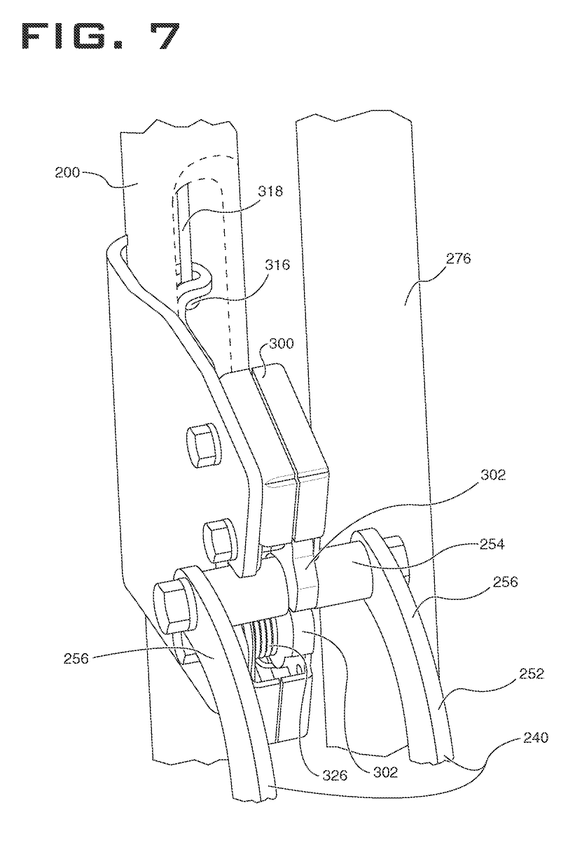

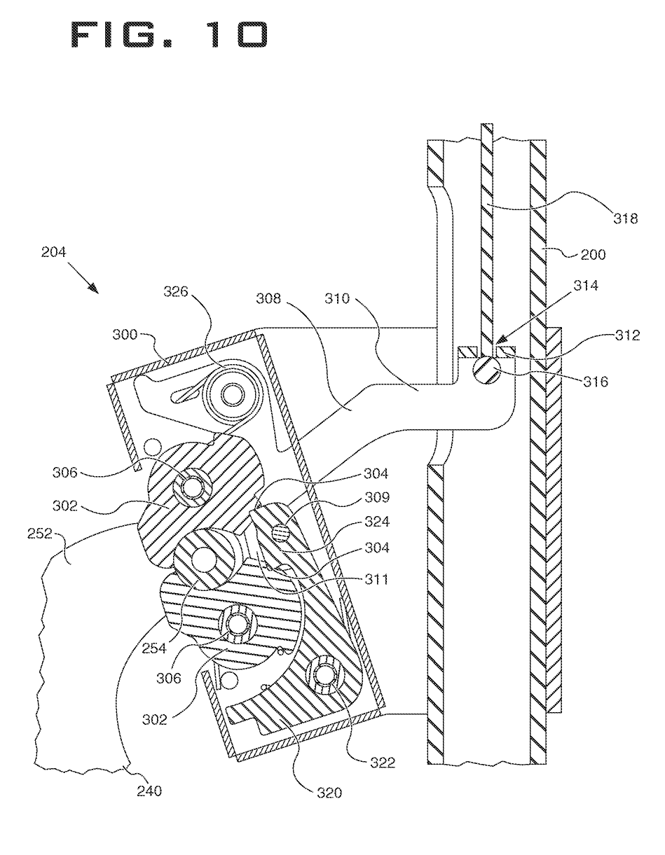

The latch assembly 204 and hooked second portion 252 of the striker arms 240 is shown in greater detail in FIGS. 7 and 10. The latch assembly 204 is a conventional double rotor, single position latch design that includes a rectangular shaped housing 300 and a pair of opposing latch rotors 302 that have one or more notches 304, the latch rotors 302 pivot about points 306 and are biased by torsion springs 326 (one shown) toward an open configuration. A latch trip lever 308 includes a lever arm 310 that includes a flange 312 with an opening 314 for receiving a ball terminus 316 of a release cable 318. Latch member 320 is designed to pivot about pin 322 and includes a block portion 324 for engaging notches 304 and a pin 309. A hooked end 311 of the latch trip lever 308 is configured to engage pin 309 to pull the block portion 324 and disengage the latch member 320 from the rotor notches 304, the latch member 320 being spring biased toward the latch rotors 302.

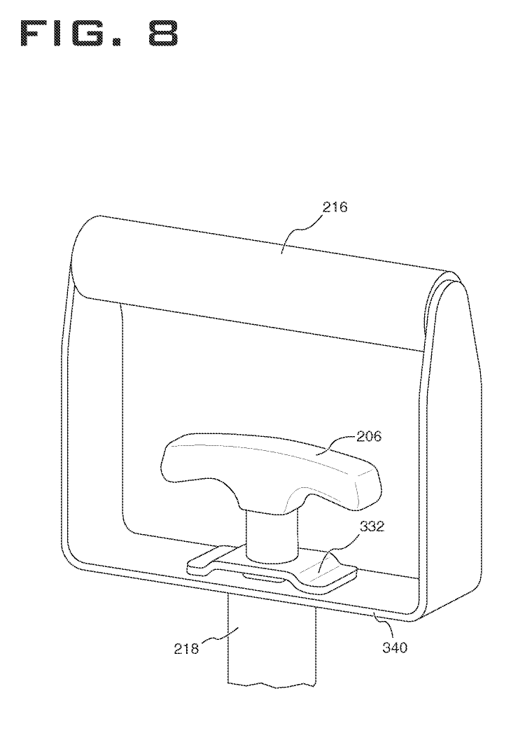

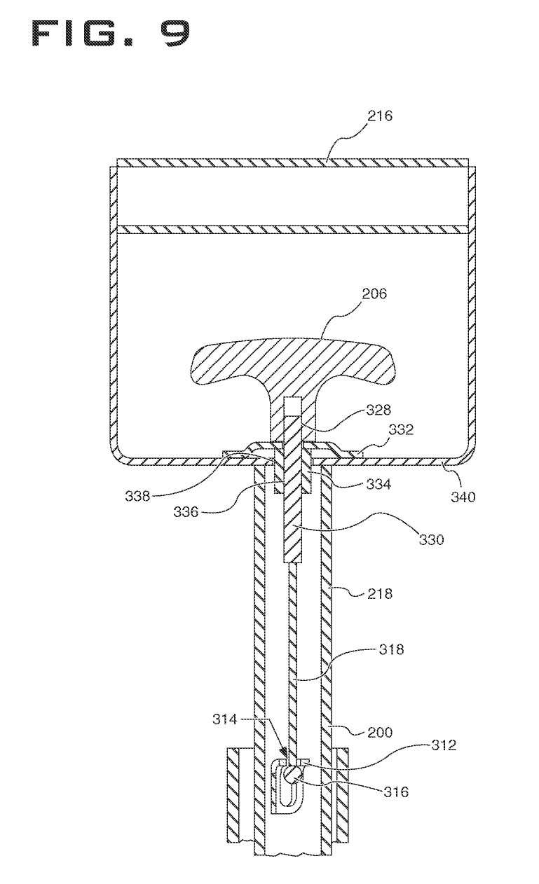

FIGS. 8-10 provide a more detailed view of the handle 216 and latch release 206. The latch release handle 206 is a T-shaped handle with a threaded bore 328 configured to receive a threaded rod end 330 of cable 318 that is associated with the latch trip lever 308. An end plate 332 is provided with a rectangular block 334, also having threaded bore 336. Accordingly, when both the block 334 and latch release 206 are threaded onto the rod end 330, they move together as the latch release 206 is pulled upward by an operator. The rectangular cross-section of the block 334 is configured for sliding engagement with a rectangular opening 338 in the bottom cross-member 340 of the handle 216, which prevents the plate 332 from rotating about the connector rod 330.

Referring again to FIGS. 3-6, a plurality of stops are provided to restrict the range of movement of the lower ladder 106. A first, metal U-shaped stop 258 may be welded to an outer surface 260 of the lower rails 144,146 with a first stop surface 262 that is coplanar with a front edge 264 of the lower rails 144,146. The first stop 258 is configured to engage a second stop 266 that is connected to an outer surface 268 of the upper rails 134,136, the second stop 266 including a resilient member 270. The first and second stops 258,266 serve to limit upward movement of the lower ladder 106, as shown in FIGS. 4 and 6.

A third stop 272 is also provided on the outer surface 268 of the upper rails 134,136 that may be coplanar with a rear edge 274 of the upper rails 134,136. The third stop 272 consists of a metal block that is welded to the upper rails 134,126, and is configured to engage a forward surface 282 of the second section 156 of rail arm 148, thereby providing a downward limit to movement of the lower ladder 106, as shown in FIGS. 3 and 5.

An access hand rail 108 may be included that is connected via an upper handrail support 276 to side plate 230, and via a lower handrail support 278 to a handrail bracket 280 that is connected (bolted, welded or otherwise) to the outer surface 268 of the right side upper rail 136.

### INDUSTRIAL APPLICABILITY

The present disclosure provides an access device for large mobile machinery such as the motor grader shown in FIGS. 1-2. Referring again to FIGS. 1-2, the access device 100 generally includes a upper and lower ladders 104,106, that, when the lower ladder 106 is placed in the lowered position, allows an operator or other personnel to conveniently access the elevated platforms 30 and the operator station 16.

Once an operator has climbed the stairs from the lowered position, shown in FIGS. 3,5 to the access platform 102, the operator can raise the lower ladder 106 from a first, lowered position (FIGS. 3,5) to a second, raised position (FIGS. 4,6) by grasping handle 216 and applying a downward force. As the force is applied, the push arm 200 will move downward in a generally arcuate path 400 dictated by the pivotal connection to the striker arm 240, which is pivotally connected to both the striker bracket plates 234 at flag pin 250, and the push arm 200 at pivot pin 244. Simultaneously, the downward force on the push arm, through angular portion 212 and the pivotal connection 208 to the rail arm 148, causes the lower ladder to pivot upward in the direction of path 402 (FIG. 4) until the latch assembly 204 is engaged, and, potentially, the first stops 258 of the lower ladder 106 encounter the second stops 266 of the upper ladder 104. As the strait section 246 of the striker arm assembly 202 pivots downward, the hooked portion 252 moves upward 404 to move the striker 254 into the open latch assembly 204, causing the latch rotors 302 (FIG. 10) to rotate forward, clasping the striker 254 in position, as shown in FIGS. 7 and 10.

From the raised position, an operator standing on the access platform 102 can grasp the handle 216 and pull upward on the latch release 206, which pulls the release cable 318, and the associated latch trip lever 308. This causes the latch member 320 to release the latch rotors 302, which are biased to the open position by springs 326. This allows the operator, grasping the handle 216 to slowly lower the ladder 106 with gravity assist until the push arm 200 reaches the upper position, and the third stop 272 engages the forward surface 274 of the rail arms 148.

It should be understood that the above description is intended for illustrative purposes only. While aspects of the present disclosure have been particularly shown and described with reference to the embodiments above, it will be understood by those skilled in the art that various additional embodiments may be contemplated by modification of the disclosed components and methods without departing from the spirit and scope of what is disclosed. In particular, it should be readily appreciated that there are other applications for the disclosed access device other than on a motor grader. Such embodiments should be understood to fall within the scope of the present invention as determined based upon the claims below and any equivalents thereof.

What is claimed is:

1. An access device for a mobile machine, comprising:
a platform;
an upper, fixed position ladder having opposing rails and a plurality of steps extending between the rails, the upper ladder being connected at an upper end to the platform;
a lower ladder pivotally connected to the upper ladder, the lower ladder having opposing rails and a plurality of steps extending between the rails, at least one of the rails of the lower ladder including a rail arm that extends from a rear face of the lower ladder; and
a push arm having a push handle and a first end, the first end extending above an upper surface of the platform, the push arm having a second end pivotally connected to the rail arm, wherein a downward force on the push arm pivots the lower ladder from a lowered position to a raised position.

2. The access device of claim 1, wherein the upper ladder and lower ladder are aligned along a ladder axis when in the lowered position, the rail arm including a first section that extends from a rear face of the lower ladder at an angle relative to the axis, and a second section that extends upward from an end of the first section, the push arm being pivotally connected to the second section.

3. The access device of claim 2, wherein the second section extends upward parallel to the first axis.

4. The access device of claim 1, wherein the upper ladder and lower ladder are aligned along a ladder axis when in the lowered position, each of the rails of the lower ladder having a rail arm, the rail arms including a first section that extends from a rear face of the lower ladder at an angle relative to the axis, and a second section that extends upward from an end of the first section, the push arm being pivotally connected to the second section.

5. The access device of claim 4, wherein each rail of the upper ladder is pivotally connected at the second section of one of the rail arms of the lower ladder.

6. The access device of claim 4, further comprising a cross-member that extends between the second section of the rail arms behind the rear face of the lower ladder.

7. The access device of claim 1, further including a latch assembly connected to the push arm, and a striker arm pivotally supported by a striker bracket, the striker arm pivotally connected at a first end to the push arm wherein as the push arm moves from an upper push arm position to a lower push arm position, the striker arm pivots about the striker bracket to engage the latch assembly.

8. The access device of claim 7, wherein the striker bracket includes a first and second spaced striker bracket plates, the push arm disposed between the bracket plates.

9. The access device of claim 7, further comprising a latch release handle associated with the push handle.

10. The access device of claim 9, wherein the latch release handle is connected to a cable, the cable having an end connected to a release lever of the latch assembly.

11. The access device of claim 9, wherein the push arm includes a hollow portion, the cable being disposed within the hollow portion.

12. The access device of claim 10, wherein the latch assembly is a double latch having first and second latch rotors that are spring biased in an open position, wherein upward movement of the latch release handle acting on the cable and release lever causes the latch rotors to move to an open position.

13. The access device of claim 1, wherein the upper ladder and lower ladder are aligned along a ladder axis when in the lowered position, the rail arm including a first section that extends from a rear face of the lower ladder at an angle relative to the axis, and a second section that extends upward from an end of the first section, the push arm being pivotally connected to the second section; and
a latch assembly connected to the push arm, a striker arm pivotally supported by a striker bracket, the striker arm pivotally connected at a first end to the push arm wherein as the push arm moves from an upper push arm position to a lower push arm position, the striker arm pivots about the striker bracket to engage the latch assembly.

14. The access device of claim 13, wherein the push arm includes a vertical upper portion and angular lower portion connected to the second section of the rail arm.

15. The access device of claim 13, wherein the striker bracket includes a first and second spaced striker bracket plates, the push arm disposed between the bracket plates.

16. The access device of claim 13, further comprising a latch release handle, the latch release handle connected to a cable, the cable having an end connected to a release lever of the latch assembly, the cable being disposed within a tubular portion of the push arm.

17. A mobile machine, comprising:
a machine frame;
a plurality of traction devices supporting the machine frame;
a power source drivingly connected to at least one of the fraction devices;
a work implement operatively connected to the machine frame; and
an access device mounted to the machine frame, the access device having:
a platform;
an upper, fixed position ladder having opposing rails and a plurality of steps extending between the rails, the upper ladder being connected at an upper end to the platform;
a lower ladder pivotally connected to the upper ladder, the lower ladder having opposing rails and a plurality of steps extending between the rails, at least one of the rails of the lower ladder including a rail arm that extends from a rear face of the lower ladder; and
a push arm having a push handle and a first end, the first end extending above an upper surface of the platform, the push arm having a second end pivotally connected to the rail arm, wherein a downward force on the push arm pivots the lower ladder from a lowered position to a raised position.

18. The mobile machine of claim 17, wherein the access device further includes a latch assembly connected to the push arm, and a striker arm pivotally supported by a striker bracket, the striker arm pivotally connected at a first end to the push arm wherein as the push arm moves from an upper push arm position to a lower push arm position, the striker arm pivots about the striker bracket to engage the latch assembly.

19. The mobile machine of claim 17, wherein the upper ladder and lower ladder of the access device are aligned along a ladder axis when in the lowered position, the rail arm including a first section that extends from a rear face of the lower ladder at an angle relative to the axis, and a second section that extends upward from an end of the first section, the push arm being pivotally connected to the second section; and
a latch assembly connected to the push arm, a striker arm pivotally supported by a striker bracket, the striker arm pivotally connected at a first end to the push arm wherein as the push arm moves from an upper push arm position to a lower push arm position, the striker arm pivots about the striker bracket to engage the latch assembly.

20. An access device for a mobile machine, comprising:
a platform;
an upper, fixed position ladder having opposing rails and a plurality of steps extending between the rails, the upper ladder being connected at an upper end to the platform;
a lower ladder pivotally connected to the upper ladder, the lower ladder having opposing rails and a plurality of steps extending between the rails, at least one of the rails of the lower ladder including a rail arm that extends from a rear face of the lower ladder;
a push arm having a push handle and a first end, the first end extending above an upper surface of the platform, the push arm having a second end pivotally connected to the rail arm, wherein a downward force on the push arm pivots the lower ladder from a lowered position to a raised position;
the upper ladder and lower ladder of the access device aligned along a ladder axis when in the lowered position, the rail arm including a first section that extends from a rear face of the lower ladder at an angle relative to the axis, and a second section that extends upward from an end of the first section, the push arm being pivotally connected to the second section; and
a latch assembly connected to the push arm, a striker arm pivotally supported by a striker bracket connected to the platform, the striker arm pivotally connected at a first end to the push arm wherein as the push arm moves from an upper push arm position to a lower push arm position, the striker arm pivots about the striker bracket to engage the latch assembly.
